(19) United States
(12) Patent Application Publication
(10) Pub. No.: US 2026/0028959 A1
(43) Pub. Date: Jan. 29, 2026

(54) TENSEGRITY ADAPTIVE-GEOMETRY WAVE ENERGY CONVERTER

(71) Applicant: The Florida State University Research Foundation, Inc., Tallahassee, FL (US)

(72) Inventors: Tomas Solano, Tallahassee, FL (US); Kourosh Shoele, Tallahassee, FL (US); Eliot Quon, Tallahassee, FL (US)

(21) Appl. No.: 19/281,878

(22) Filed: Jul. 28, 2025

Related U.S. Application Data
(60) Provisional application No. 63/675,841, filed on Jul. 26, 2024.

(51) Int. Cl. F03B 13/18

(52) U.S. Cl. CPC F03B 13/18; F05B 2240/95

(57) ABSTRACT

An exemplary device is disclosed for collecting wave energy and converting the collected wave energy into electrical power. The exemplary device comprises a tensegrity buoy configured to deform in response to wave conditions, applying force to a reaction plate, which is coupled, via a spar, to a power-take-off system that converts the mechanical input into electrical energy.

### CROSS-REFERENCE TO RELATED APPLICATIONS

This application claims the benefit of U.S. Provisional Patent Application No. 63/675,841 filed on Jul. 26, 2024, entitled “TENSEGRITY ADAPTIVE-GEOMETRY WAVE ENERGY CONVERTER (TAGWEC),” which is incorporated herein by reference in its entirety.

### GOVERNMENT LICENSES RIGHTS

This invention was made with government support under 790877419 awarded by the National Science Foundation. The government has certain rights in the invention.

### BACKGROUND

Wave energy is a renewable energy resource that can provide consistent power from ocean motion. Wave energy converters (WECs) are compact systems that use a floating buoy to capture energy from vertical wave movement. However, under rough sea conditions, current WECs struggle to extract and convert wave energy into electricity.

There is a benefit to improving wave energy harvester and converter systems.

### SUMMARY

An exemplary device is disclosed for collecting wave energy and converting the collected wave energy into electrical power. The exemplary device comprises a tensegrity buoy configured to deform in response to wave conditions, applying force to a reaction plate, which is coupled, via a spar, to a power-take-off system that converts the mechanical input into electrical energy.

In the exemplary device, the tensegrity-based configuration provides large, controlled deformations of the buoy, allowing the exemplary device to tune its dynamic response to various wave conditions. This adaptability improves energy capture efficiency, broadens operational bandwidth, and enhances survivability of the exemplary device during extreme weather events.

Current WECs (e.g., those using inflatable airbags or adjustable panels) are limited in the range and complexity of achievable geometries and allow only small deformations. In contrast, the exemplary device's tensegrity configuration supports a broad spectrum of shape configurations and provides greater adaptability to changing wave environments.

Furthermore, while current WECs employ tensegrity in power-take-off substructures, the exemplary device utilizes tensegrity as a primary structural and shape-changing mechanism of its buoy. This dual functionality provides both structural rigidity and geometric adaptability, distinguishing the exemplary device from current WECs.

In an aspect, a tensegrity adaptive-geometry wave energy converter is disclosed comprising: a fixed foundation; a spar extending from the fixed foundation; a power-take-off system coupled to the tether; and a tensegrity buoy coupled to the power-take-off system.

In some embodiments, the fixed foundation is configured to be anchored to an off-shore sea floor.

In some embodiments, the tensegrity buoy defines a buoy volume that is adjustable.

In some embodiments, the tensegrity buoy is actuatable between a maximum volume state and a minimum volume state.

In some embodiments, the tensegrity buoy is actuatable between a first sea state configuration defining a first volume and a second sea state configuration defining a second volume.

In some embodiments, the first sea state configuration defines a maximum buoy volume, and the second sea state configuration defines a buoy volume of 75% or less of the maximum buoy volume.

In some embodiments, the tensegrity buoy is actuatable to a stowed configuration while attached to the power-take-off.

In some embodiments, the tensegrity buoy is arranged in the stowed configuration is response to a rough sea state.

In some embodiments, the tensegrity buoy includes tensegrity actuators that adjust the geometry of the tensegrity buoy to adjust a buoy volume.

In some embodiments, the tensegrity buoy includes a shape actuator controlling a buoy shape.

In another aspect, a tensegrity adaptive-geometry wave energy converter is disclosed comprising: a tensegrity buoy actuatable between a maximum buoy volume and a minimum buoy volume in response to a sea state.

In some embodiments, the sea state includes a wave amplitude.

In some embodiments, the sea state includes a wave frequency.

In some embodiments, the tensegrity buoy is actuatable to a stowed configuration defining the minimum buoy volume.

In some embodiments, the tensegrity buoy is actuatable to maintain a constant volume while changing shape.

In yet another aspect, a tensegrity adaptive-geometry wave energy converter is disclosed comprising: a fixed foundation; a spar extending from the fixed foundation; and a tensegrity buoy coupled to the spar.

In some embodiments, the tensegrity buoy is actuatable between: a first sea state configuration defining a first volume, a second sea state configuration defining a second volume, and a stowed configuration in response to a rough sea state

In some embodiments, the first sea state defines a calm sea state, and the second sea state defines a moderate sea state.

In some embodiments, wherein a buoy volume of the tensegrity buoy is actuatable in response to a wave amplitude.

In some embodiments, the spar is retractable relative to the fixed foundation.

This summary is illustrative only and is not intended to be in any way limiting. Other aspects, features, and advantages of the devices or processes described herein will become apparent in the detailed description set forth herein, taken in conjunction with the accompanying figures, wherein like reference numerals refer to like elements.

### BRIEF DESCRIPTION OF DRAWINGS

The methods, apparatuses, and systems is explained in even greater detail in the following drawings. The drawings are merely exemplary and certain features may be used singularly or in combination with other features. The drawings are not necessarily drawn to scale.

FIGS. 1A-1C each shows an example tensegrity adaptive-geometry wave energy converter (WEC) device configured to collect wave energy and convert the collected wave energy to electric power, in accordance with an illustrative embodiment.

FIG. 2 shows an operation of the exemplary device in a water body (e.g., sea, river), in accordance with an illustrative embodiment.

FIG. 3 shows an example adaptive geometry configuration, referred to as a point absorber configuration, of the exemplary device, in accordance with an illustrative embodiment.

### DETAILED DESCRIPTION

Following below are more detailed descriptions of concepts related to, and implementations of, methods, apparatuses, and systems for a tensegrity adaptive-geometry wave energy converter. The figures illustrate exemplary implementations in detail and the present disclosure is not limited to the details or methodology set forth in the description or illustrated in the figures. The terminology used herein is for the purpose of description only and should not be regarded as limiting

### Example System

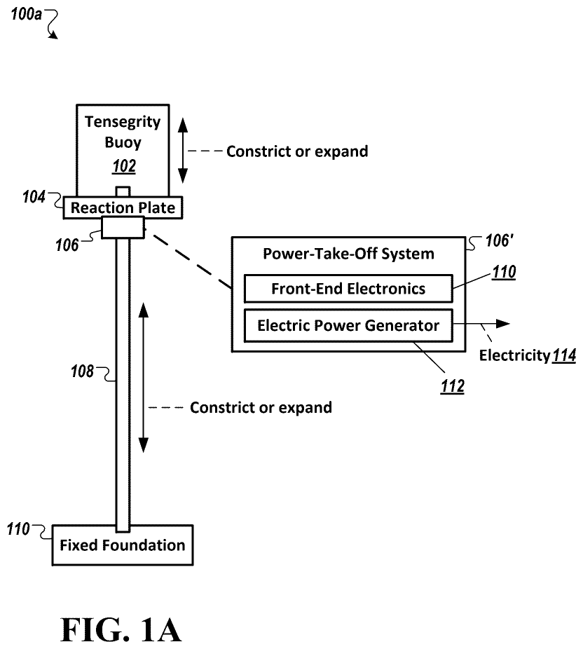

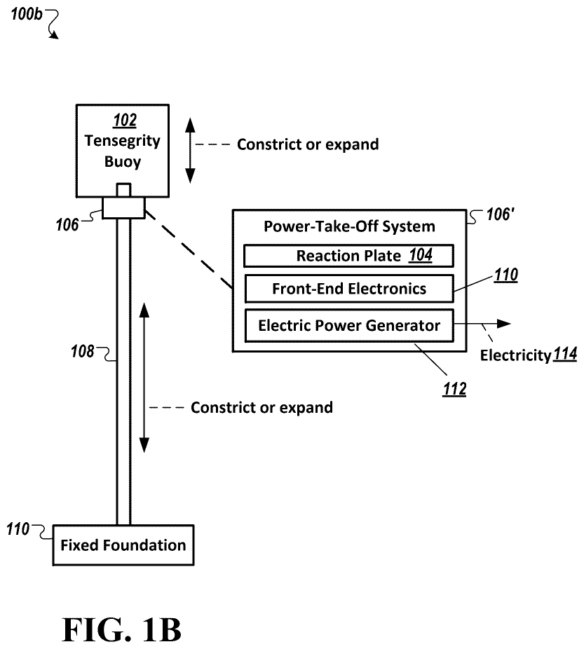

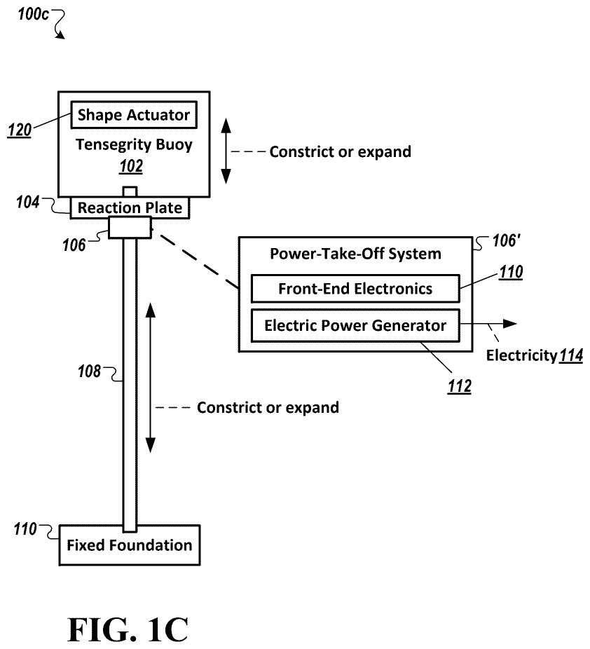

FIGS. 1A-1C each shows an example tensegrity adaptive-geometry wave energy converter (WEC) device 100 (shown as 100a-100c), submerged in a water body (e.g., sea, river), for collecting wave energy and converting the collected wave energy to electric power, using (i) a tensegrity buoy 102 configured to apply, via adjustments in its buoy volume (e.g., expansion, constriction caused by waves), a force or pressure to a reaction plate 104, and (ii) a power-take-off (PTO) system 106 (shown as 106′), coupled to the tensegrity buoy via a spar 108 (e.g., longitudinal shaft), configured to convert the force or pressure to electric power (e.g., electricity). Each device 100 can be anchored, via a fixed foundation 110, to an offshore sea or river floor. The spar 108 is configured to (i) extend from the fixed foundation 110, (ii) couple the tensegrity buoy 102, reaction plate 104, and power-take-off system 106 along a longitudinal axis, and (iii) constrict or expand depending on the water body state.

In FIG. 1A, the reaction plate 104 is a separate component from the power-take-off system 106. In FIG. 1B, the reaction plate 104 is part of the power-take-off system 106. In FIG. 1C, the tensegrity buoy 102 further employs a shape actuator 120.

Tensegrity Buoy (102). In the examples shown in FIGS. 1A-1C, the tenserity buoy 102 defines a buoy volume that can be adjusted by waves (e.g., of sea or river), when the device 100 is submerged in the water body. Specifically, the tenserity buoy 102 is actuable (e.g., expandable, constrictable) between a first water body state configuration defining a first buoy volume and a second water body state configuration defining a second buoy volume. The first buoy volume is the maximum volume of the tensegrity buoy 102, and the second buoy volume is the minimum volume or a volume of 75% or less of the maximum volume.

In one embodiment, the tensegrity buoy 102 is actuable to a stowed (e.g., constricted) configuration while coupled, via the spar 108, to the power-take-off system 102. In another embodiment, the tensegrity buoy 102 is arranged in the stowed configuration in response to a rough sea state. In yet another embodiment, the tensegrity buoy 102 is actuable to maintain a constant volume while changing shape.

In FIG. 1C, the tensegrity buoy 102 employs the shape actuator 120 configured to control the buoy shape/volume adjustment (e.g., speed, angle, etc.) depending on the state of the water body.

Power-Take-Off System (106). In the examples shown in FIG. 1A-1C, the PTO system 106 is configured to convert a force or pressure into electric power (e.g., electricity). Specifically, the PTO 106 can receive, via front-end electronics 110, the force or pressure that the tensegrity buoy 102 applies, via adjustments of buoy volume, to the reaction plate 104. The PTO system 106 can then generate, via an electric power generator 112, electricity 114 using the received force or pressure. The force or pressure the tensegrity buoy 102 applies to the reaction plate 104 can vary its amplitude depending on the water body state, including wave amplitude or wave frequency. The higher the force or pressure amplitude, the more electricity 114 the electric power generator can produce. The generated electricity 114 can be subsequently used to power other devices (e.g., cameras, data loggers) that are operatively coupled to the exemplary device and configured to collect water body and/or weather condition data.

In FIG. 1C, reaction plate 104 is implemented as part of the PTO system 106 and can be operatively coupled to the electric power generator 112 for easy force-electricity conversion.

### Example Operation in a Water Body

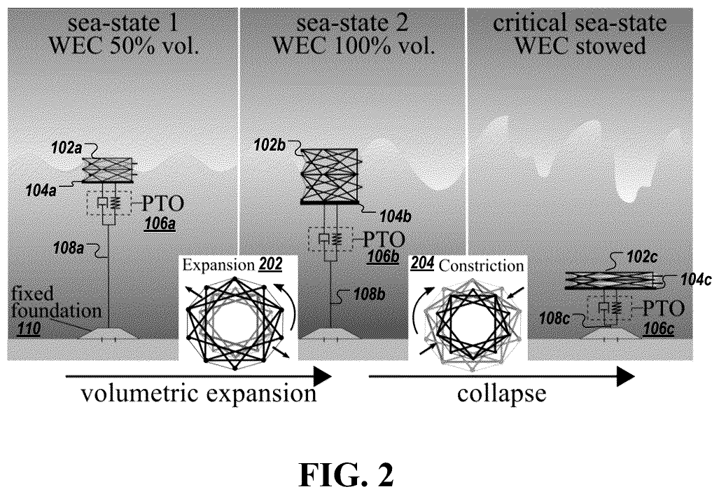

FIG. 2 shows an operation of the exemplary device (see 100, FIGS. 1A-1C) in a water body (e.g., sea, river). As shown, the exemplary device is configured with shape-changing capabilities to increase survivability during extreme weather, increase energy generation, and facilitate large-scale deployment.

In FIG. 2, the exemplary device comprises a floating buoy 102 (shown as 102a-102c) connected to a submerged reaction plate 104 (shown as 104a-104c) by a spar 108 (shown as 108a-108c). The relative motion of the buoy 102 and reaction plate 104, caused by adjustments in buoy volume (e.g., which is caused by water waves), generates electric power through a power-take-off system 106 (shown as 106a-106c).

The configuration to adaptively change the geometry of the buoy 102 is facilitated through the tensegrity of the buoy 102. Configured with tensegrity principles, the exemplary device is lightweight and deformable, able to toggle between shape configurations with low actuation cost. These characteristics allow for ease of stowage, deployment, and enhanced wave-energy conversion performance of the exemplary device.

The efficiency of the exemplary device can be improved by incorporating an automatic control (see 120, FIG. 1C) that optimizes the relative motion between the buoy 102 and the reaction plate 104. This control scheme can tune the oscillation of the exemplary device to the incident wave elevation (e.g., sea-state) by changing the size and shape of the exemplary device's components, maximizing the power transfer from the wave to the exemplary device.

Collapsible systems that can be expanded to the appropriate size provide ease of deployment at large scales. The same collapsibility (e.g., 202, 204) that allows for easy deployment can also be used to stow the exemplary device in extreme weather conditions, increasing the exemplary system's survivability. Using tensegrity principles (for buoy 102) also increases the exemplary device's power capture for a larger range of operating conditions.

The exemplary device can be employed for wave energy collection/absorption. A plurality of exemplary devices can form a wave energy farm, set offshore in designated areas with appropriate sea conditions. An individual exemplary device can be used as a survey buoy that powers itself and collects sea and weather condition data. Besides the exemplary device, the same oscillation tuning achieved by the shape-changing capabilities can be used to stabilize offshore platforms (e.g., for offshore wind turbines).

### Example Adaptive Geometry Configuration

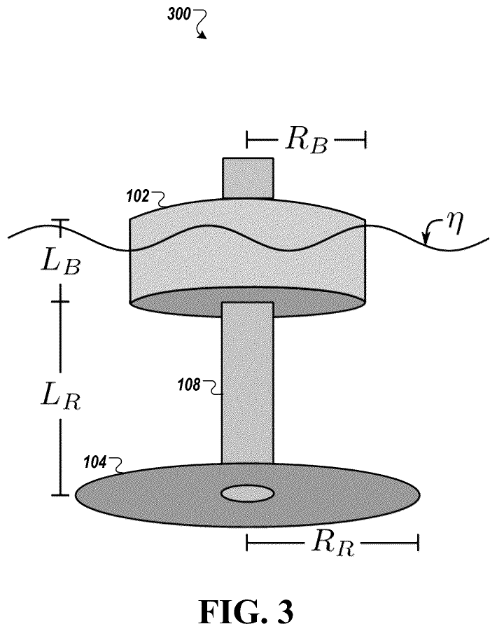

FIG. 3 shows an example adaptive geometry configuration 300, referred to as a point absorber configuration, of the exemplary device. As shown, to have an adaptive geometry configuration, the exemplary device is implemented as a point-absorber with a floating buoy 102 configured to change shape and size using a tensegrity mechanism. The buoy can move along a spar 108, attached to a reaction plate 104 submerged underwater, that can also change shape and size (see FIG. 2).

While the buoy 102 and reaction plate 104, in FIG. 3, have a cylindrical shape, their geometries are not limited to only a cylindrical shape and can even be asymmetrical shapes. The relative motion between the buoy 102 and reaction plate 104 (caused by adjustments in buoy volume) can be converted to energy (e.g., electricity) via a power-take-off (PTO) unit, which, in some embodiments, can be a linear hydraulic damper.

### DISCUSSION

There are many different wave energy capturing technologies, but all face similar challenges that should be overcome: the structural cost, operations and maintenance costs, and the deployment technique for large-scale farms. For example, Pardonner, D., et al., 2020, Numerical Model Development of a Variable-Geometry Attenuator Wave Energy Converter, In International Conference on Offshore Mechanics and Arctic Engineering (Vol. 84416, p. V009T09A031), American Society of Mechanical Engineers, disclose a variable-geometry attenuator that comprises inflatable airbags placed on either side of a base central steel cylinder and float on the water surface. The airbags can be inflated or deflated depending on the sea state.

Kelly et al. [1] disclosed a variable-geometry oscillating surge WEC. This is an oscillating surge WEC (OSWEC), considered a flat plate hinged to the seafloor. The OSWEC has slots in the plate that can be opened or closed by flaps, offering controllability. This is a form of shape changing that effectively adjusts the drag on the plate and allows the dynamics to be tuned to specific sea conditions for optimal use.

Also, a challenge specific to point-absorber technologies is their relatively narrow bandwidth for power absorption, corresponding to reduced capacity factor. The device's size, shape, and structural robustness define the structural costs, the device's energy conversion performance, and ease of deployment.

Kurniawan et al. [2] disclosed a floating airbag point absorber. The airbag can expand and contract, thereby changing the dynamic response of the device. The airbag is, however, limited in the shapes it can produce.

Zou and Abdelkhalik [3] proposed a variable-geometry point-absorber wave energy converter. The proposed device was designed with multiple controllable panels and a gas chamber. The controllable panels allowed for small changes in the buoy's shape by effectively changing the angle of the tapered (conical) bottom of the buoy. This device is limited not only in the shapes the buoy can achieve but also to relatively small changes in the geometry.

Vasquez et al. [4] and Lin et al. [5] disclosed point absorbers capable of changing their shape to tune their dynamics to the changing sea conditions for optimal power capture. Both of these technologies specifically change the shape of the floating buoy. However, both are limited in the shapes that they can achieve. Furthermore, the proposed system of Lin et al. is significantly limited to small deformations of the buoy shape.

Unlike current systems, the exemplary device is not limited in shape and can undergo large deformation. Because the shape-changing mechanism depends on tensegrity, the exemplary device can have various arrangements. The ability to change the shape of the buoy can increase the efficiency and bandwidth of the exemplary device. Additionally, the airbag design of current systems is a flexible and deformable surface, while the exemplary device is based on a rigid structure design.

### CONCLUSION

For purposes of this description, certain advantages and novel features of the aspects and configurations of this disclosure are described herein. The described methods, systems, and apparatus should not be construed as limiting in any way. Instead, the present disclosure is directed toward all novel and nonobvious features and aspects of the various disclosed aspects, alone and in various combinations and sub-combinations with one another. The disclosed methods, systems, and apparatus are not limited to any specific aspect, feature, or combination thereof, nor do the disclosed methods, systems, and apparatus require that any one or more specific advantages be present or problems be solved.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and/or hardware systems chosen and on designer choice. All such variations are within the scope of the disclosure.

Features disclosed in this specification (including any accompanying claims, abstract, and drawings), and/or all of the steps of any method or process so disclosed, may be combined in any combination, except combinations where at least some of such features and/or steps are mutually exclusive. The claimed features extend to any novel one, or any novel combination, of the features disclosed in this specification (including any accompanying claims, abstract, and drawings), or to any novel one, or any novel combination, of the steps of any method or process so disclosed.

As used in the specification and the appended claims, the singular forms “a”, “an”, and “the” include plural referents unless the context clearly dictates otherwise. Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about”, it will be understood that the particular value forms another aspect. It will be further understood that the endpoints of each of the ranges are significant both in relation to the other endpoint, and independently of the other endpoint. The terms “about” and “approximately” are defined as being “close to” as understood by one of ordinary skill in the art.

The terms “coupled”, “connected”, and the like as used herein mean that two members are joined together, directly or indirectly. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

Certain terminology is used in the following description for convenience only and is not limiting. The words “inner” and “outer” refer to directions toward and away from, respectively, the geometric center of the described feature or device. The words “distal” and “proximal” refer to directions taken in context of the item described and, with regard to the instruments herein described, are typically based on the perspective of the practitioner using such instrument, with “proximal” indicating a position closer to the practitioner and “distal” indicating a position further from the practitioner. The terminology includes the above-listed words, derivatives thereof, and words of similar import.

Throughout the description and claims of this specification, the word “comprise” and variations of the word, such as “comprising” and “comprises”, means “including but not limited to”, and is not intended to exclude, for example, other additives, components, integers or steps. “Exemplary” means “an example of” and is not intended to convey an indication of a preferred or ideal aspect. “Such as” is not used in a restrictive sense, but for explanatory purposes.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the form disclosed. Many modifications and variations will be apparent to those of ordinary skill in the art without departing from the scope and spirit of the present disclosure.

The following patents, applications, and publications, as listed below and throughout this document, are hereby incorporated by reference in their entirety herein.
[1] Kelly, M., et al., 2021, Annual performance of the second-generation variable-geometry oscillating surge wave energy converter, Renewable Energy, 177, pp. 242-258.
[2] Kurniawan, A., et al., 2017, Wave energy absorption by a floating air bag, Journal of Fluid Mechanics, 812, pp. 294-320.
[3] Zou, S. and Abdelkhalik, O., 2020, Modeling of a Variable-Geometry Wave Energy Converter, IEEE Journal of Oceanic Engineering.
[4] Vasquez, R. E., Crane III, et al., 2014, Analysis of a planar tensegrity mechanism for ocean wave energy harvesting, Journal of Mechanisms and Robotics, 6(3), p. 031015.
[5] Lin, M., et al., Kinematics and dynamics of a tensegrity-based water wave energy harvester, Journal of Robotics, 2016.

What is claimed is:

1. A tensegrity adaptive-geometry wave energy converter comprising:
a fixed foundation;
a spar extending from the fixed foundation;
a power-take-off system coupled to the tether; and
a tensegrity buoy coupled to the power-take-off system.

2. The tensegrity adaptive-geometry wave energy converter of claim 1, wherein the fixed foundation is configured to be anchored to an off-shore sea floor.

3. The tensegrity adaptive-geometry wave energy converter of claim 1, wherein the tensegrity buoy defines a buoy volume that is adjustable.

4. The tensegrity adaptive-geometry wave energy converter of claim 1, wherein the tensegrity buoy is actuatable between a maximum volume state and a minimum volume state.

5. The tensegrity adaptive-geometry wave energy converter of claim 1, wherein the tensegrity buoy is actuatable between a first sea state configuration defining a first volume and a second sea state configuration defining a second volume.

6. The tensegrity adaptive-geometry wave energy converter of claim 5, wherein the first sea state configuration defines a maximum buoy volume and the second sea state configuration defines a buoy volume of 75% or less of the maximum buoy volume.

7. The tensegrity adaptive-geometry wave energy converter of claim 1, wherein the tensegrity buoy is actuatable to a stowed configuration while attached to the power-take-off.

8. The tensegrity adaptive-geometry wave energy converter of claim 7, wherein the tensegrity buoy is arranged in the stowed configuration is response to a rough sea state.

9. The tensegrity adaptive-geometry wave energy converter of claim 1, wherein the tensegrity buoy includes tensegrity actuators that adjust the geometry of the tensegrity buoy to adjust a buoy volume.

10. The tensegrity adaptive-geometry wave energy converter of claim 1, wherein the tensegrity buoy includes a shape actuator controlling a buoy shape.

11. A tensegrity adaptive-geometry wave energy converter comprising:
a tensegrity buoy actuatable between a maximum buoy volume and a minimum buoy volume in response to a sea state.

12. The tensegrity adaptive-geometry wave energy converter of claim 11, wherein the sea state includes a wave amplitude.

13. The tensegrity adaptive-geometry wave energy converter of claim 11, wherein the sea state includes a wave frequency.

14. The tensegrity adaptive-geometry wave energy converter of claim 11, wherein the tensegrity buoy is actuatable to a stowed configuration defining the minimum buoy volume.

15. The tensegrity adaptive-geometry wave energy converter of claim 11, wherein the tensegrity buoy is actuatable to maintain a constant volume while changing shape.

16. A tensegrity adaptive-geometry wave energy converter comprising:
a fixed foundation;
a spar extending from the fixed foundation; and
a tensegrity buoy coupled to the spar.

17. The tensegrity adaptive-geometry wave energy converter of claim 16, wherein the tensegrity buoy is actuatable between:
a first sea state configuration defining a first volume,
a second sea state configuration defining a second volume, and
a stowed configuration is response to a rough sea state

18. The tensegrity adaptive-geometry wave energy converter of claim 17, wherein the first sea state defines a calm sea state, and the second sea state defines a moderate sea state.

19. The tensegrity adaptive-geometry wave energy converter of claim 16, wherein a buoy volume of the tensegrity buoy is actuatable in response to a wave amplitude.

20. The tensegrity adaptive-geometry wave energy converter of claim 16, wherein the spar is retractable relative to the fixed foundation.
